(19) United States
(12) Patent Application Publication
(10) Pub. No.: US 2025/0371958 A1
(43) Pub. Date: Dec. 4, 2025

(54) INFORMATION PROCESSING APPARATUS AND METHOD OF CONTROLLING INFORMATION PROCESSING APPARATUS

(71) Applicant: Toshiba Tec Kabushiki Kaisha, Tokyo (JP)

(72) Inventor: Kazunori UEMATSU, Tagata Shizuoka (JP)

(21) Appl. No.: 19/029,971

(22) Filed: Jan. 17, 2025

(30) Foreign Application Priority Data
Jun. 4, 2024 (JP) 2024-090754

(51) Int. Cl. G08B 21/02; G06F 3/14; G06Q 30/0601

(52) U.S. Cl. CPC G08B 21/0266; G06F 3/14; G06Q 30/0633

(57) ABSTRACT

According to an embodiment, an information processing apparatus receives a beacon signal from a beacon device detachably attached to the information processing apparatus. The information processing apparatus acquires information relating to a distance between the information processing apparatus and the beacon device on the basis of the beacon signal. The information processing apparatus displays notification information on a display device in accordance with the acquired information.

### CROSS-REFERENCE TO RELATED APPLICATIONS

This application is based upon and claims the benefit of priority from the prior Japanese Patent Application No. 2024-90754, filed on Jun. 4, 2024, the entire contents of which are incorporated herein by reference.

### FIELD

Embodiments described herein generally relate to an information processing apparatus and a method of controlling the information processing apparatus.

### BACKGROUND

In recent years, shopping carts to which terminal devices such as tablet terminals are attached have been used in stores such as supermarkets and mass retailers. Further, in terminal devices attached to shopping carts (hereinafter, referred to as cart terminals), the following cart terminals have been proposed, which are capable of processing periodic signals, called beacons, using near-field communication technologies such as Bluetooth (registered trademark).

Meanwhile, a system has been proposed in which lost children are found using beacons in commercial facilities such as amusement facilities when parents and children who have come to the commercial facilities are unintentionally separated, i.e., when children get lost.

However, the conventional system described above has not been sufficiently considered for use in stores, and it is difficult to apply the system as it is.

### BRIEF DESCRIPTION OF THE DRAWINGS

FIG. 1 is a diagram showing an example of a schematic configuration of a lost child prevention system according to a first embodiment.

FIG. 2A is a schematic view showing an example of a shopping cart according to the first embodiment.

FIG. 2B is a schematic view showing an example of the shopping cart according to the first embodiment.

FIG. 3 is a block diagram showing an example of a hardware configuration of a terminal device according to the first embodiment.

FIG. 4 is a diagram showing an example of a data structure of a lost child determination table according to the first embodiment.

FIG. 5 is a block diagram showing an example of a hardware configuration of a beacon transmitter according to the first embodiment.

FIG. 6 is a diagram showing an example of a screen displayed on a display portion of the terminal device according to the first embodiment.

FIG. 7 is a diagram showing an example of a screen displayed on the display portion of the terminal device according to the first embodiment.

FIG. 8 is a diagram showing an example of a screen displayed on the display portion of the terminal device according to the first embodiment.

FIG. 9 is a diagram showing an example of a screen displayed on the display portion of the terminal device according to the first embodiment.

FIG. 10 is a block diagram showing an example of functional configurations of the terminal device and the beacon transmitter according to the first embodiment.

FIG. 11 is a sequence diagram showing an example of control processing of a lost child prevention system S according to the first embodiment.

FIG. 12 is a flowchart showing an example of control processing of the terminal device according to the first embodiment.

FIG. 13 is a diagram showing an example of a schematic configuration of a lost child prevention system according to a second embodiment.

### DETAILED DESCRIPTION

According to one embodiment, an information processing apparatus is an apparatus that is operated by a customer who comes to a store and is capable of moving around the store together with the customer. The information processing apparatus includes a beacon device, an input device, a communication interface, a display device, and a controller. The beacon device is detachably attached to the information processing apparatus and transmits a beacon signal. The input device inputs product identification information of a product to be purchased. The product identification information is information capable of identifying the product. The communication interface communicates with the beacon device. The display device displays information relating to the product and notification information for the customer. The controller acquires the product identification information input by the input device and registers the information relating to the product identified by the acquired product identification information, as information of a product to be purchased. The controller displays the registered information relating to the product on the display device. The controller receives the beacon signal transmitted from the beacon device via the communication interface. The controller acquires information relating to a distance between the information processing apparatus and the beacon device on the basis of the received beacon signal. Further, the controller displays first notification information on the display device in accordance with the acquired information relating to the distance, the first notification information being different from the information relating to the product.

Hereinafter, embodiments of a terminal device 1 will be described with reference to the drawings. Note that in the drawings the same reference symbols denote the same or similar portions. Further, in the embodiments to be described below, the terminal device 1 used in stores and the like will be described as an example of an information processing apparatus, but the embodiments do not limit the present invention.

### First Embodiment

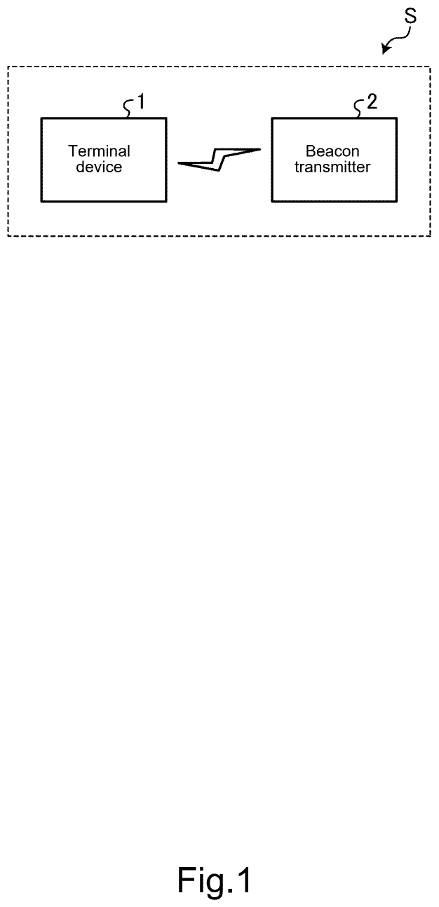

FIG. 1 is a diagram showing an example of a schematic configuration of a lost child prevention system according to this embodiment. As shown in FIG. 1, a lost child prevention system S includes a terminal device 1 and a beacon transmitter 2.

The terminal device 1 and the beacon transmitter 2 are communicably connected to each other by near-field communication such as Bluetooth Low Energy (BLE (registered Note that in this embodiment the communicable trademark)). state is a concept including not only bidirectional communication in which the terminal device 1 and the beacon transmitter 2 can transmit and receive signals to and from each other, but also unidirectional communication in which the terminal device 1 receives signals transmitted by the beacon transmitter 2. In this embodiment, the description proceeds assuming that the terminal device 1 and the beacon transmitter 2 perform the former bidirectional communication.

Here, the terminal device 1 and the beacon transmitter 2 form a one-to-one pair. For example, the terminal device 1 and the beacon transmitter 2 form a pair by holding its own identification information (e.g., universally unique identifier (UUID)) as well as identification information of the other paired device. In other words, a certain terminal device 1 can transmit and receive information to and from one beacon transmitter 2. Hereinafter, the identification information used to uniquely identify the terminal device 1 is also referred to as a terminal ID, and the identification information used to uniquely identify the beacon transmitter 2 is also referred to as a beacon ID.

The terminal device 1 is an information processing apparatus that is operated by a customer who comes to a store and is capable of moving around the store together with the customer. The terminal device 1 is attached to a shopping cart 3 (described below) and can thus move around the store with the customer. For example, the terminal device 1 is a movable, portable terminal device such as a tablet terminal or a smartphone.

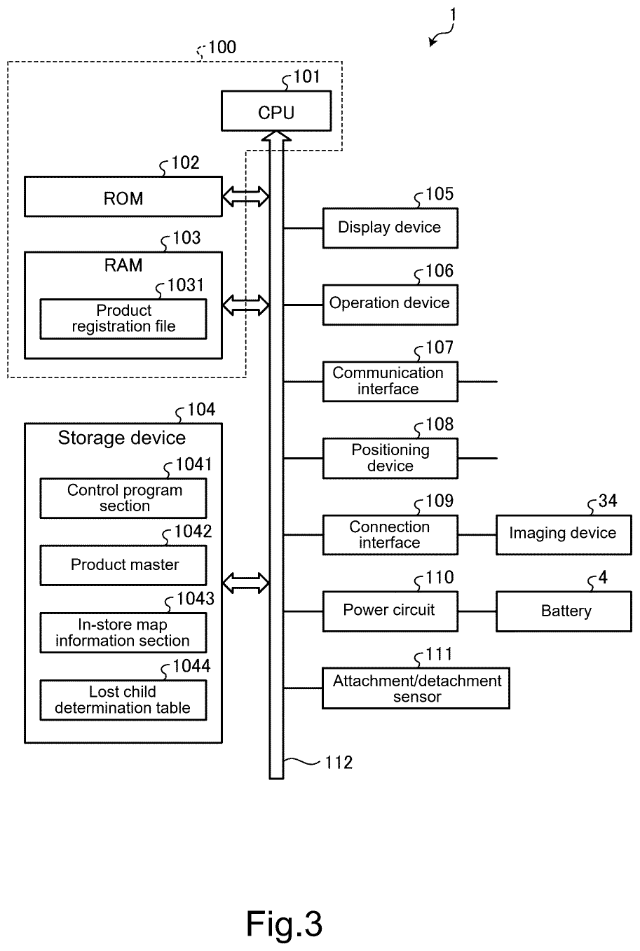

The terminal device 1 has a product registration function of registering products to be purchased by customers. Specifically, when a customer finds a product to be purchased in a product sales floor of the store, the customer registers the product by using an imaging device 34 of the terminal device 1 (see FIG. 3) to read a code symbol such as a bar code or two-dimensional code given to the product.

Further, upon reception of a checkout instruction from an operation device 106 of the terminal device 1 (see FIG. 3), the terminal device 1 transmits product information of the product registered by the terminal device 1 to a checkout machine not shown in the figure.

Further, the terminal device 1 receives various types of information from the beacon transmitter 2. Specifically, the terminal device 1 receives a beacon signal transmitted from the beacon transmitter 2. The beacon signal includes a beacon ID of the beacon transmitter 2 and location information of the beacon transmitter 2.

Further, upon reception of the beacon signal, the terminal device 1 authenticates the beacon transmitter 2. Specifically, upon reception of the beacon signal from the beacon transmitter 2, the terminal device 1 determines whether or not the beacon ID included in the beacon signal matches the beacon ID stored in association with the terminal ID stored in a ROM 102 of the terminal device 1 (see FIG. 3). If it is determined that they match each other, the terminal device 1 determines that the beacon signal has been transmitted from the beacon transmitter 2 that forms the pair with the terminal device 1, and acquires that beacon signal. Further, if it is determined that they do not match each other, the terminal device 1 determines that the beacon signal has been transmitted from another beacon transmitter other than the beacon transmitter 2 that forms the pair with the terminal device 1, and discards that beacon signal.

Further, the terminal device 1 uses a positioning device 108 (see FIG. 3) to acquire location information of the terminal device 1. When the terminal device 1 acquires location information indicating the location of the terminal device 1 within the store, the terminal device 1 calculates the distance between the terminal device 1 and the beacon transmitter 2 on the basis of the above-mentioned location information and the location information of the beacon transmitter 2 included in the beacon signal. The terminal device 1 then displays a screen corresponding to the calculated distance between the terminal device 1 and the beacon transmitter 2 on a display device 105. Note that the method of acquiring the location information and the method of calculating the distance will be described later.

The beacon transmitter 2 is an example of a beacon device. The beacon transmitter 2 is detachably attached to the terminal device 1 that forms the pair with the beacon transmitter 2.

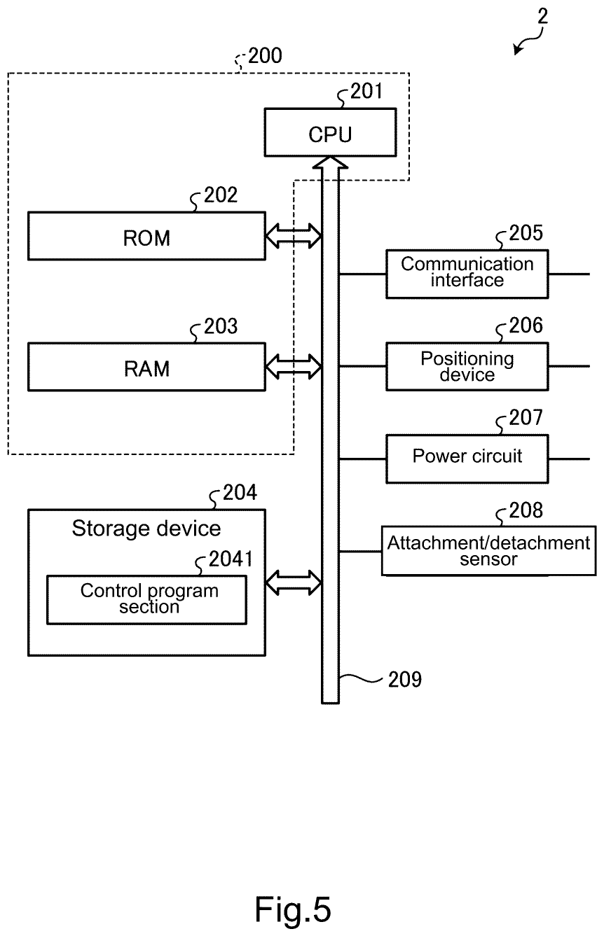

The beacon transmitter 2 can enter two states of an off-state and an on-state. The off-state corresponds to power-off or a state with reduced power consumption such as sleep or hibernation (hereinafter, collectively referred to as hibernation. The on-state is not hibernation. The beacon transmitter 2 repeatedly transmits beacon signals at specified intervals stored in a ROM 202 of the beacon transmitter 2 (see FIG. 5) in the on-state. On the other hand, the beacon transmitter 2 does not transmit beacon signals in the off-state.

When the beacon transmitter 2 detects that it has been detached from its predetermined position attached to the terminal device 1, the beacon transmitter 2 switches from the off-state to the on-state. The beacon transmitter 2 then uses a positioning device 206 of the beacon transmitter 2 (see FIG. 5) to acquire location information indicating the location of the beacon transmitter 2 within the store. The beacon transmitter 2 then transmits a beacon signal including the beacon ID and the location information of the beacon transmitter 2 to the terminal device 1. Note that the method of acquiring the location information will be described later.

Note that in this embodiment the communication between the terminal device 1 and the beacon transmitter 2 is possible in the entire region of the store.

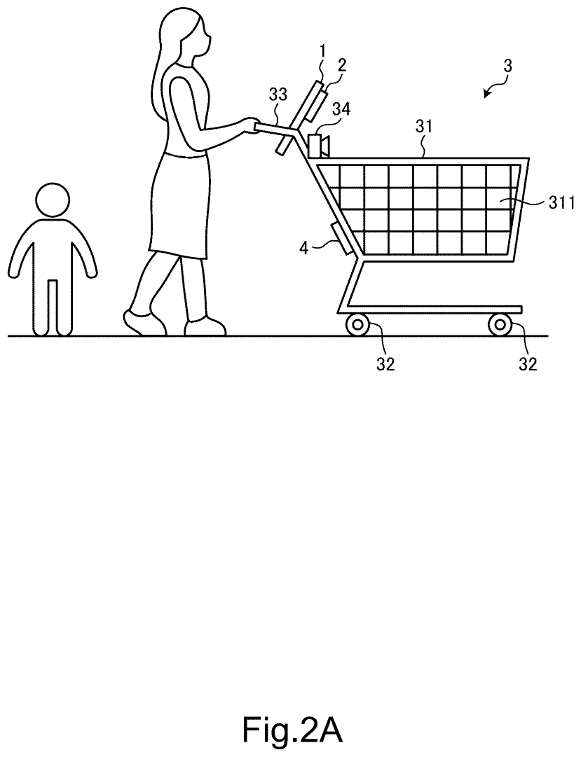

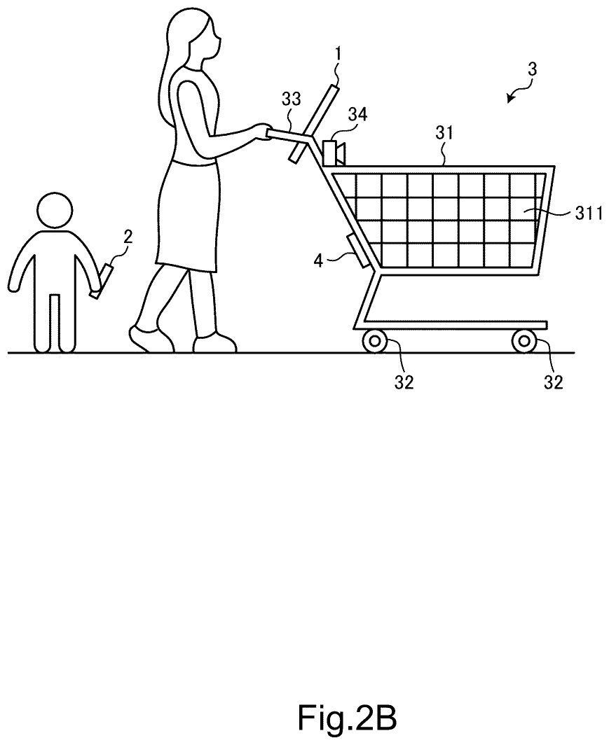

Next, the shopping cart 3 including the terminal device 1 will be described. FIGS. 2A and 2B are schematic views showing an example of the shopping cart 3 according to this embodiment.

As shown in FIGS. 2A and 2B, the shopping cart 3 includes a basket-shaped storage portion 31 with an open top, rotary casters 32 disposed on the lower part of the storage portion 31, a handle 33 coupled to the storage portion 31 and the casters 32 and grasped by the customer when the shopping cart 3 is moved, and the like.

The storage portion 31 has an open top configuration with the side surfaces and the bottom surface being surrounded by a mesh-like grid 311 in a substantially rectangular shape, thereby allowing the products stored in the storage portion 31 to be visible from the outside. Note that the side surfaces and the bottom surface may be configured using a wall surface instead of the mesh-like grid 311.

Further, the shopping cart 3 is equipped with the terminal device 1 near the handle 33. Furthermore, the terminal device 1 is equipped with the beacon transmitter 2 detachably at a predetermined position of the terminal device 1. The shopping cart 3 is also equipped with the imaging device 34 near the edge of the opening of the storage portion 31. The shopping cart 3 is also equipped with a battery 4, for example, on the side surface or bottom surface of the storage portion 31.

The beacon transmitter 2 operates in two states: as shown in FIG. 2A, the beacon transmitter 2 is attached to a predetermined position of the terminal device 1; and as shown in FIG. 2B, the beacon transmitter 2 is detached from the predetermined position of the terminal device 1 and carried by a non-operator (e.g., child) who comes to the store together with an operator of the shopping cart 3 (e.g., guardian).

As shown in FIG. 2A, in the state in which the beacon transmitter 2 is attached to a predetermined position of the terminal device 1, the beacon transmitter 2 is in the off-state. Further, when the beacon transmitter 2 detects that it has been detached from the predetermined position of the terminal device 1, the beacon transmitter 2 changes to the on-state. As shown in FIG. 2B, in the state in which the beacon transmitter 2 is detached from the terminal device 1, the beacon transmitter 2 is in the on-state. Further, when the beacon transmitter 2 detects that it has been attached to the predetermined position of the terminal device 1, the beacon transmitter 2 changes to the off-state.

The imaging device 34 is an imaging device such as a digital camera. The imaging device 34 is installed with the imaging direction facing the opening of the storage portion 31. In other words, the imaging direction and imaging range of the imaging device 34 are set such that the imaging device 34 can capture images of the products that are put in and out of the storage portion 31. Note that the imaging device 34 may be included in the terminal device 1.

The imaging device 34 captures images of the products stored in or taken from the storage portion 31 and outputs the captured images to the terminal device 1. Here, the images mean still images or moving images in units of frames.

The battery 4 is a rechargeable secondary battery. The battery 4 accumulates power supplied from an external power source via a power supply unit not shown in the figure, and supplies the accumulated power to the terminal device 1 mounted on the shopping cart 3.

Note that the configuration of the shopping cart 3 is not limited to the example shown in FIGS. 2A and 2B. For example,, the terminal device 1 may be configured to be detachable from the shopping cart 3. In this case, a portable terminal (tablet terminal, smartphone, etc.) owned by the customer himself/herself or rented by the store may be attached to the shopping cart 3 to be used as the terminal device 1.

Next, a hardware configuration of the terminal device 1 will be described. FIG. 3 is a block diagram showing an example of a hardware configuration of the terminal device 1 according to this embodiment.

As shown in FIG. 3, the terminal device 1 includes a central processing unit (CPU) 101, which is an example of a processor, a read only memory (ROM) 102, a random access memory (RAM) 103, and a storage device 104.

The CPU 101 comprehensively controls each part of the terminal device 1. The ROM 102 stores various programs. For example, the ROM 102 stores a terminal ID and a beacon ID corresponding to the terminal ID. The RAM 103 is a work space in which the programs and various types of data are expanded. For example, the RAM 103 includes a product registration file 1031.

The product registration file 1031 is a data table or database for managing products registered by the terminal device 1. The product registration file 1031 stores, for example, a transaction management memory and transaction data (product code, product name, price, and the number of products).

The transaction management memory is, for example, identification information (identification number) that is associated with a storage area that stores information relating to one transaction handled by the terminal device 1. Specifically, the transaction management memory is stored in association with the transaction data handled in one transaction. The transaction data stores, for example, product information such as a product code, a product name, and a price of a product registered in one transaction, and the number of registered products, among the products stored in a product master 1042 to be described later.

Returning to FIG. 3, the storage device 104 is a nonvolatile memory such as a hard disk drive (HDD) or flash memory that retains stored information even when power is turned off. The storage device 104 includes a control program section 1041, the product master 1042, an in-store map information section 1043, and a lost child determination table 1044.

The control program section 1041 stores a control program for controlling the terminal device 1. The CPU 101, the ROM 102, the RAM 103, and the storage device 104 are connected to each other via a bus 112. The CPU 101, the ROM 102, and the RAM 103 constitute the controller 100 with a computer configuration. In other words, the controller 100 executes the control processing of the terminal device 1, which will be described later, by the CPU 101 operating in accordance with the control program section 1041 that is stored in the ROM 102 or the storage device 104 and expanded in the RAM 103.

The product master 1042 is a data table or database for managing the prices and the like of the products sold in the store. The product master 1042 stores product information such as a product name and a price of the product corresponding to a product code, in association with the product code capable of identifying the type of product sold in the store.

The in-store map information section 1043 is a data table or database that stores an in-store map showing the layout in the store, including the locations of aisles, product sales floors, and checkout machines in the store; and the layout locations of the product sales floors. Here, the layout in the store is so-called map data including the locations and shapes of the aisles in the store. The layout locations of the product sales floors are information in which coordinate positions where products are located are associated with product information of products (e.g., product code). The format of the in-store map information section 1043 can be any format, but for example, a format similar to a road map used in car navigation systems (data expressing aisles with links and nodes) can be used.

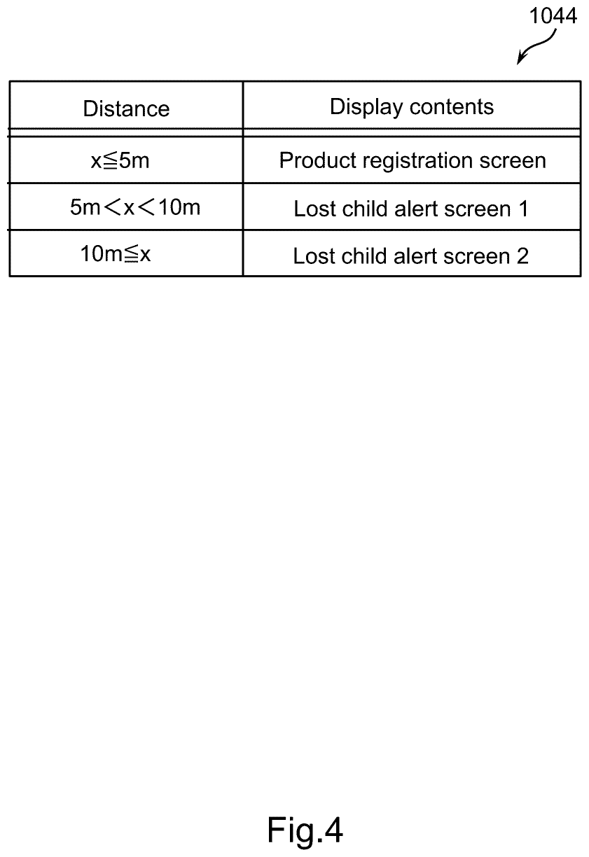

The lost child determination table 1044 is a data table or database that defines the relationship between a distance from the terminal device 1 to the beacon transmitter 2 and a display content of a display screen corresponding to the distance. FIG. 4 is a diagram showing an example of a data structure of the lost child determination table 1044. As shown in FIG. 4, the lost child determination table 1044 stores the distance and the display content in association with each other. Here, the display content is an example of information relating to the distance between the terminal device 1 and the beacon transmitter 2.

The distance represents, for example, a distance between the terminal device 1 and the beacon transmitter 2. The distance is calculated on the basis of the location information of the terminal device 1 acquired via the positioning device 108 of the terminal device 1 (see FIG. 3) and the location information of the beacon transmitter 2 included in the beacon signal.

Here, the distance can be calculated using known technologies. For example, the Euclidean distance calculated from the location information of the terminal device 1 and the location information of the beacon transmitter 2 may be used as the distance.

The display content represents the type of screen displayed on the display device 105. In FIG. 4, for the purpose of convenience, the texts explaining respective screens are described in the Display Contents column, but the display contents store contents such as image data corresponding to each screen and identification information capable of identifying the contents.

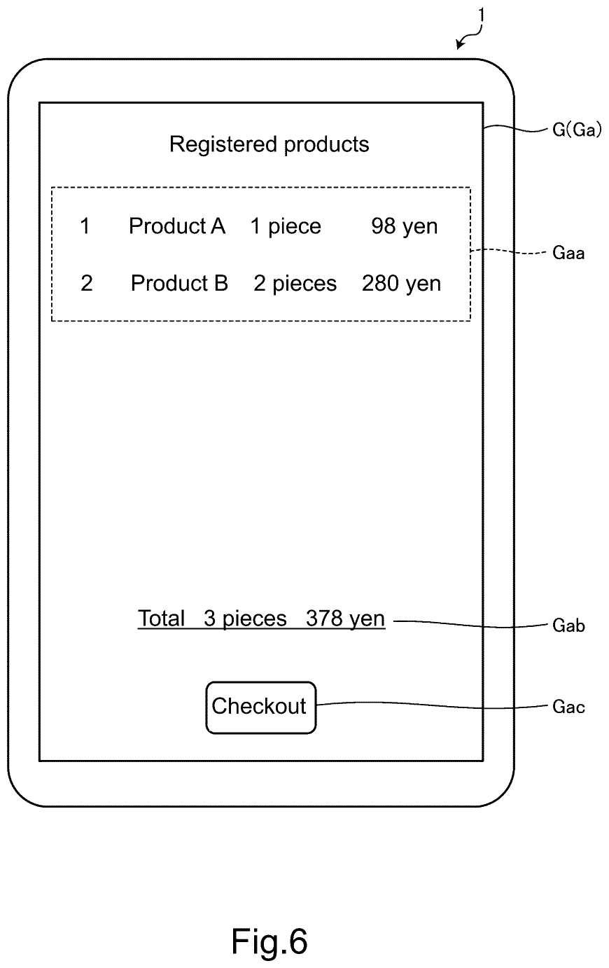

For example, in FIG. 4, if the distance calculated from the location information of the terminal device 1 and the location information of the beacon transmitter 2 is “3 m”, the display content corresponding to that distance is a “product registration screen” that is a screen for supporting product registration processing. In this case, a product registration screen Ga (see FIG. 6) corresponding to the “product registration screen” is displayed on the display device 105 of the terminal device 1. Note that the “product registration screen” in this embodiment is the default screen that is displayed on the display device 105 during shopping (product registration) using the terminal device 1. In other words, when the “product registration screen” is displayed, it means that the beacon transmitter 2 is located in the vicinity of the terminal device 1, that is, the child is less likely to get lost.

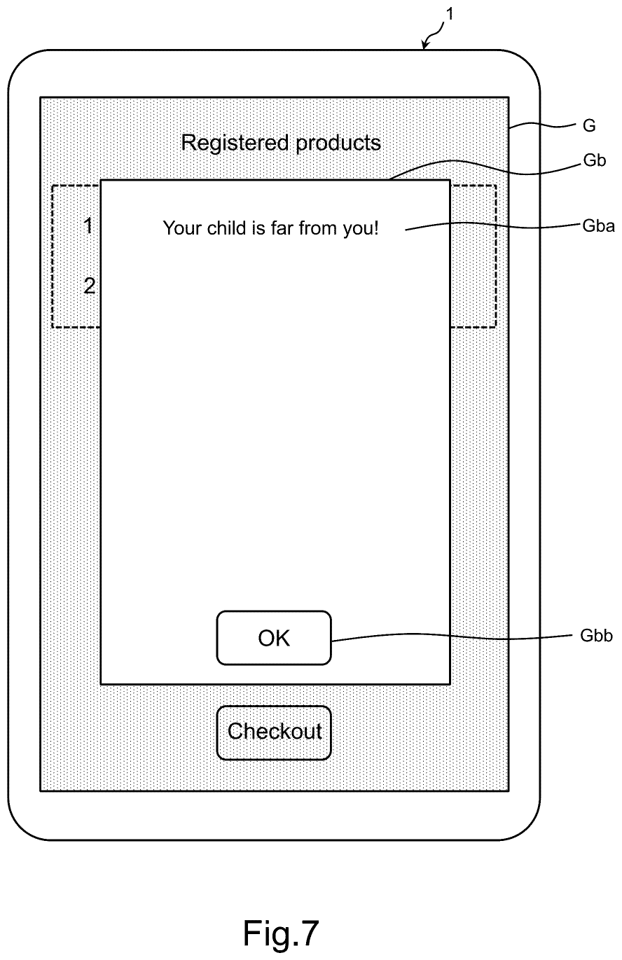

Further, if the distance calculated from the location information of the terminal device 1 and the location information of the beacon transmitter 2 is “6 m”, the display content corresponding to that distance is a “lost child alert screen 1”. The “lost child alert screen 1” is a notification of a situation in which the child is likely to get lost. In this case, a lost child alert screen Gb (see FIG. 7) corresponding to the “lost child alert screen 1” is displayed on the display device 105 of the terminal device 1.

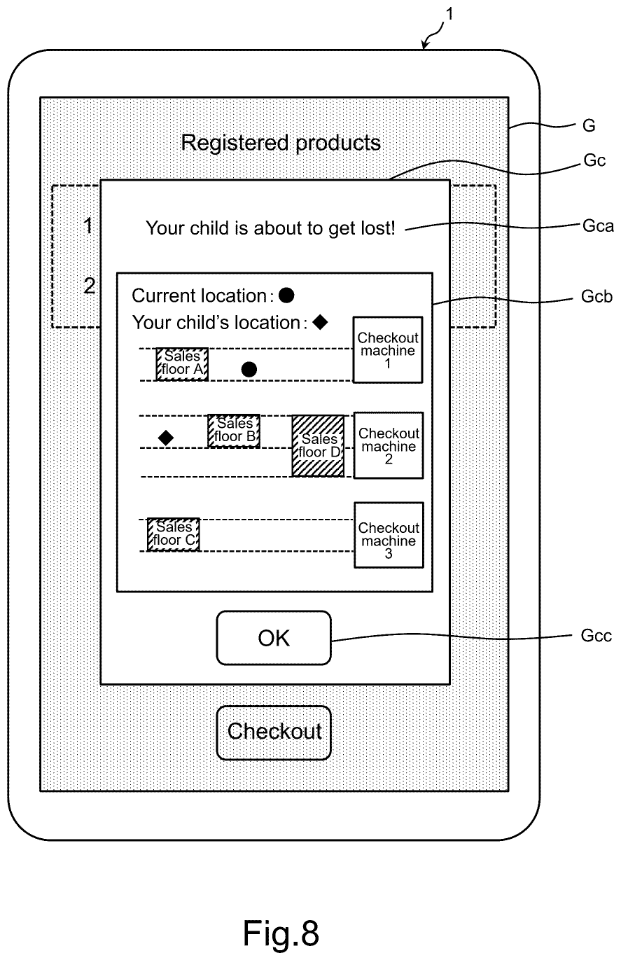

Further, if the distance calculated from the location information of the terminal device 1 and the location information of the beacon transmitter 2 is “12 m”, the display content corresponding to that distance is a “lost child alert screen 2”. The “lost child alert screen 2” is a notification of a situation in which the child is lost. In this case, a lost child alert screen Gc (see FIG. 8) corresponding to the “lost child alert screen 2” is displayed on the display device 105 of the terminal device 1.

Returning to FIG. 3, the controller 100 is connected to the display device 105, the operation device 106, a communication interface 107, the positioning device 108, a connection interface 109, a power circuit 110, and an attachment/detachment sensor 111 via the bus 112.

The display device 105 is a device such as a liquid crystal display (LCD). The display device 105 displays various types of information under the control of the CPU 101. The operation device 106 is a touch panel provided to the display device 105. The operation device 106 outputs operation contents input via an input device to the CPU 101. Note that the operation device 106 may be an input device such as a keyboard or a pointing device.

The communication interface 107 is an interface for communicating with the beacon transmitter 2 through near-field communication such as BLE. The communication interface 107 transmits and receives various types of information to and from the beacon transmitter 2.

The positioning device 108 acquires location information indicating the location of the terminal device 1 in the store. In this embodiment, the operator of the shopping cart 3 (e.g., guardian) operates the terminal device 1, and the terminal device 1 thus exists at the same location as the operator of the shopping cart 3. Therefore, the location of the terminal device 1 identified by the positioning device 108 corresponds to the location of the operator of the shopping cart 3 in the store.

Note that the method of acquiring the location information is not particularly limited, and any publicly-known and commonly-used methods can be employed. For example, indoor positioning is performed using Wi-Fi (registered trademark), so that the location of the terminal device 1 in the store is identified, and information relating to the identified location of the terminal device 1 (hereinafter, referred to as “location information of the terminal device 1”) is acquired.

When the indoor positioning method described above is employed, the positioning device 108 first measures the radio wave strengths obtained when a plurality of access points not shown in the figure (hereinafter also referred to as APs) communicate with the terminal device 1. The plurality of access points are installed in aisles, product shelves on which products are placed, and the like in the store. On the basis of each measured radio wave strength, the positioning device 108 then identifies the relative location of the terminal device 1 with respect to each AP. The positioning device 108 identifies the location of the terminal device 1 (the location of the operator of the shopping cart 3) in the store on the basis of the identified relative location of the terminal device 1 and the installation location of each AP.

Further, as another method, the positioning device 108 may identify the location of the terminal device 1 by a positioning function of a global positioning system (GPS) of the terminal device 1 and acquire the location information of the terminal device 1. Further, in locations where GPS positioning is difficult to perform due to weak radio waves, such as underground floors, positioning may be performed by installing a base station that transmits signals including location information. Such indoor positioning technology is called indoor messaging system (IMES), in which the location of the terminal device 1 can be identified when the terminal device 1 receives signals transmitted by the base station.

The connection interface 109 is an interface for connecting peripheral devices. The connection interface 109 is a wired or wireless interface that conforms to a near-field communication standard, such as universal serial bus (USB) or Bluetooth (registered trademark). In this embodiment, the connection interface 109 is connected to the imaging device 34 serving as an example of the input device.

The power circuit 110 is a circuit that supplies power to each hardware of the terminal device 1. The power circuit 110 is connected to the battery 4. The power circuit 110 supplies power to each hardware by, for example, stepping down the voltage supplied from the battery 4 to the operating voltage of each hardware.

The attachment/detachment sensor 111 is a sensor that detects that the beacon transmitter 2 is attached to or detached from the terminal device 1. The attachment/detachment sensor 111 is, for example, an object detection sensor capable of detecting whether or not the beacon transmitter 2 is disposed at a predetermined position of the terminal device 1. Note that the attachment/detachment sensor 111 may be a vibration detection sensor or weight sensor capable of detecting contact with or impact on the terminal device 1.

Next, the hardware configuration of the beacon transmitter 2 will be described. FIG. 5 is a block diagram showing an example of a hardware configuration of the beacon transmitter 2 according to this embodiment.

As shown in FIG. 5, the beacon transmitter 2 includes a CPU 201, which is an example of a processor, a ROM 202, a RAM 203, and a storage device 204.

The CPU 201 comprehensively controls each part of the beacon transmitter 2. The ROM 202 stores various programs. The RAM 203 is a work space in which the programs and various types of data are expanded.

The storage device 204 is a nonvolatile memory such as a HDD or flash memory that retains stored information even when the power is turned off. The storage device 204 includes a control program section 2041.

The control program section 2041 stores a control program for controlling the beacon transmitter 2. The CPU 201, the ROM 202, the RAM 203, and the storage device 204 are connected to each other via a bus 209. The CPU 201, the ROM 202, and the RAM 203 constitute a controller 200 with a computer configuration. In other words, the controller 200 executes the control processing of the beacon transmitter 2, which will be described later, by the CPU 201 operating in accordance with the control program section 2041 that is stored in the ROM 202 or the storage device 204 and expanded in the RAM 203.

The controller 200 is connected to a communication interface 205, a positioning device 206, a power circuit 207, and an attachment/detachment sensor 208 via the bus 209.

The communication interface 205 is an interface for communicating with the terminal device 1 through near-field communication such as BLE. The communication interface 205 transmits and receives various types of information to and from the terminal device 1.

The positioning device 206 acquires location information indicating the location of its beacon transmitter 2 in the store. In this embodiment, a person who carries the beacon transmitter 2 is assumed to be a non-operator (e.g., child) who comes to the store together with the operator of the shopping cart 3, and the beacon transmitter 2 thus exists at the same location as the non-operator. Therefore, the location of the beacon transmitter 2 identified by the positioning device 206 corresponds to the location of the non-operator in the store.

Note that the method of acquiring the location information performed by the positioning device 206 is not particularly limited, and any publicly-known and commonly-used methods can be employed similar to the positioning device 108.

The power circuit 207 is a circuit that supplies power to each hardware of the beacon transmitter 2. The power circuit 207 is electrically connected to the terminal device 1 via a connection portion of the terminal device 1 not shown in the figure when the beacon transmitter 2 is installed at a predetermined position of the terminal device 1. The power circuit 207 supplies power to each hardware by, for example, stepping down the voltage supplied from the terminal device 1 to the operating voltage of each hardware. Note that the power circuit 207 may be configured to include a battery (not shown) to supply power to each hardware of the beacon transmitter 2. Further, the power circuit 207 may also be configured to be connected to the battery 4 when the beacon transmitter 2 is installed at a predetermined position of the terminal device 1.

The attachment/detachment sensor 208 is a sensor that detects that the beacon transmitter 2 is attached to or detached from the terminal device 1. The attachment/detachment sensor 208 is, for example, an object detection sensor capable of detecting whether or not the beacon transmitter 2 is disposed at a predetermined position of the terminal device 1. Note that the attachment/detachment sensor 208 may be a vibration detection sensor or weight sensor capable of detecting contact with or impact on the terminal device 1.

Next, various screens displayed in a display region G of the display device 105 of the terminal device 1 will be described. FIG. 6 is a diagram showing an example of a screen displayed on the display device 105 of the terminal device 1 according to this embodiment. A display control section 1004 of the terminal device 1, which will be described later, displays a product registration screen Ga including a region Gaa, a region Gab, and a button Gac on the display device 105. Here, the product registration screen Ga is a screen that supports the product registration processing.

In the region Gaa, the product information of registered products and the number of registered products are displayed. Specifically, in the region Gaa, the product information relating to one transaction stored in the product registration file 1031 is displayed. In the region Gab, the total number of registered products and the total amount of money of the registered products are displayed. Specifically, in the region Gab, the total number of products and the total amount of money of products relating to one transaction stored in the product registration file 1031 are displayed. A button Gac is an operation element for instruction to perform checkout. Specifically, when the operator of the shopping cart 3 (terminal device 1) operates the button Gac, the controller 100 of the terminal device 1 receives the checkout instruction accordingly.

FIG. 7 is a diagram showing an example of a screen displayed on the display device 105 of the terminal device 1 according to this embodiment. The display control section 1004 of the terminal device 1 displays a lost child alert screen Gb including a region Gba and a button Gbb on the display device 105. Here, the lost child alert screen Gb is a screen for notifying a situation in which the child is likely to get lost.

Here, it is favorable that the display control section 1004 grays out the product registration screen Ga to make the operation on the product registration screen Ga unacceptable when displaying the lost child alert screen Gb, and then displays the lost child alert screen Gb on the display device 105. This prevents the operator of the terminal device 1 from registering additional products even if the operator of the terminal device 1 is concentrating on shopping, thereby enabling the operator to notice a situation in which the child is likely to get lost and to prevent the child from getting lost before that situation happens.

In the region Gba, a message is displayed, the message notifying that the operator of the terminal device 1 and the child carrying the beacon transmitter 2 are located far from each other. The button Gbb is an operation element for notifying the controller 100 of the terminal device 1 that the operator of the terminal device 1 has confirmed the lost child alert screen Gb. Specifically, when the operator of the terminal device 1 operates the button Gbb, the display control section 1004 cancels the display of the lost child alert screen Gb and displays the product registration screen Ga on the display device 105 accordingly.

FIG. 8 is a diagram showing an example of a screen displayed on the display device 105 of the terminal device 1 according to this embodiment. The display control section 1004 of the terminal device 1 displays a lost child alert screen Gc including a region Gca, a region Gcb, and a button Gcc on the display device 105. Here, the lost child alert screen Gc is a screen for notifying a situation in which the child is lost.

Here, it is favorable that the display control section 1004 grays out the product registration screen Ga to make the operation on the product registration screen Ga unacceptable when displaying the lost child alert screen Gc, and then display the lost child alert screen Gc on the display device 105. This prevents the operator of the terminal device 1 from registering additional products even if the operator of the terminal device 1 is concentrating on shopping, thereby enabling the operator to notice and cope with a situation in which the child is lost.

In the region Gca, a message is displayed, the message notifying that the operator of the terminal device 1 and the child carrying the beacon transmitter 2 are located far from each other. In the region Gcb, the in-store map stored in the in-store map information section 1043, the location information of the terminal device 1, and the location information of the beacon transmitter 2 are displayed. At that time, it is favorable that the location information of the terminal device 1 and the location information of the beacon transmitter 2 are overlaid on the in-store map stored in the in-store map information section 1043 and displayed on the display device 105. The button Gcc is an operation element for notifying the controller 100 of the terminal device 1 that the operator of the terminal device 1 has confirmed the lost child alert screen Gc. Specifically, when the operator of the terminal device 1 operates the button Gcc, the display control section 1004 cancels the display of the lost child alert screen Gc and displays the product registration screen Ga on the display device 105 accordingly.

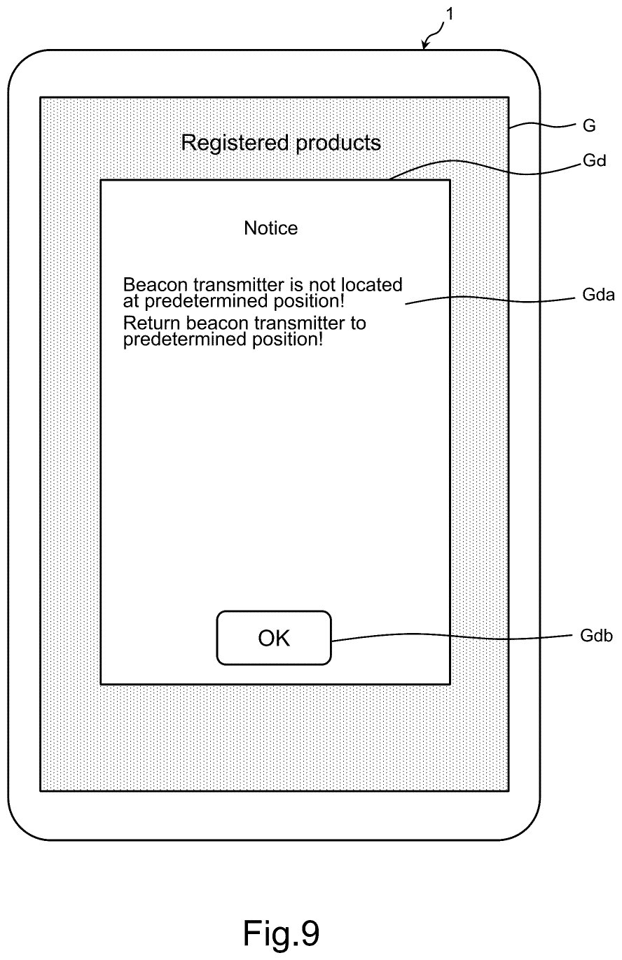

FIG. 9 is a diagram showing an example of a screen displayed on the display device 105 of the terminal device 1 according to this embodiment. The display control section 1004 of the terminal device 1 displays an attachment alert screen Gd including a region Gda and a button Gdb on the display device 105.

Here, it is favorable that the display control section 1004 grays out the product registration screen Ga to make the operation on the product registration screen Ga unacceptable when displaying the attachment alert screen Gd, and then display the attachment alert screen Gd on the display device 105. This makes it possible to notify the operator of the terminal device 1 that the beacon transmitter 2 is not correctly attached to a predetermined position of the terminal device 1.

In the region Gda, a message is displayed, the message notifying that the beacon transmitter 2 is not correctly attached to a predetermined position of the terminal device 1. The button Gdb is an operation element for notifying the controller 100 of the terminal device 1 that the operator of the terminal device 1 has confirmed the attachment alert screen Gd. Specifically, when the operator of the terminal device 1 operates the button Gdb, the display control section 1004 cancels the display of the attachment alert screen Gd and displays the product registration screen Ga on the display device 105 accordingly.

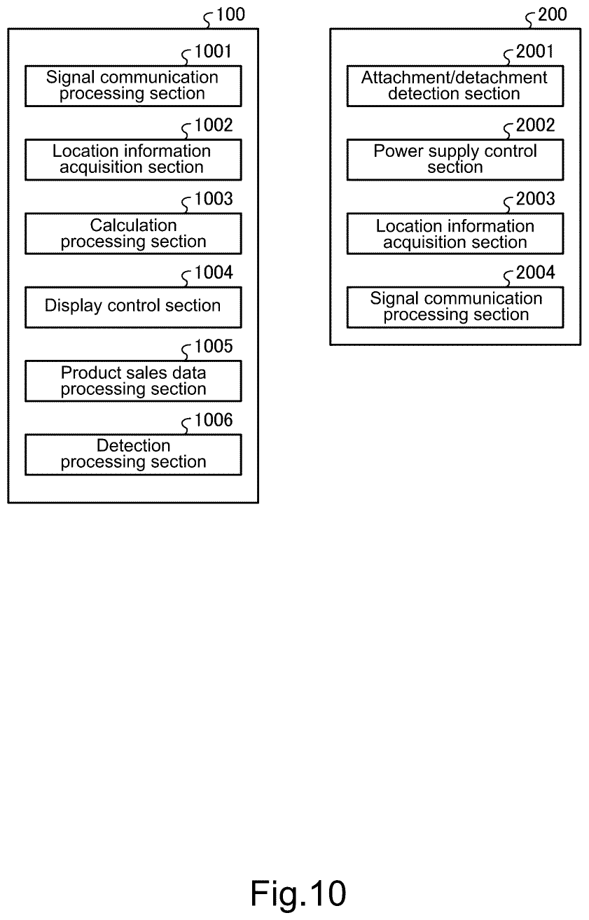

Next, functional configurations of the terminal device 1 and the beacon transmitter 2 will be described. FIG. 10 is a block diagram showing an example of the functional configurations of the terminal device 1 and the beacon transmitter 2 according to this embodiment. As shown in FIG. 10, the controller 100 of the terminal device 1 includes a signal communication processing section 1001, a location information acquisition section 1002, a calculation processing section 1003, the display control section 1004, a product sales data processing section 1005, and a detection processing section 1006 as the functional configuration. Further, the controller 200 of the beacon transmitter 2 includes an attachment/detachment detection section 2001, a power supply control section 2002, a location information acquisition section 2003, and a signal communication processing section 2004 as the functional configuration. Note that the functional configurations of the terminal device 1 and the beacon transmitter 2 are not limited to those described above.

Specifically, the controller 100 (CPU 101 serving as a processor) of the terminal device 1 achieves the functional configuration described above by executing the control program section 1041 stored in the storage device 104. Note that in this embodiment the functional configuration described above is a software configuration achieved by the cooperation of the processor of the terminal device 1 and programs, but it is not limited thereto and may be a hardware configuration in which part or all of the functional configuration is achieved by a dedicated circuit or the like. Further, the controller 200 (CPU 201 serving as a processor) of the beacon transmitter 2 achieves the functional configuration described above by executing the control program section 2041 stored in the storage device 204. Note that in this embodiment the functional configuration described above is a software configuration achieved by the cooperation of the processor of the beacon transmitter 2 and programs, but it is not limited thereto and may be a hardware configuration in which part or all of the functional configuration is achieved by a dedicated circuit or the like.

The signal communication processing section 1001 is an example of reception means. The signal communication processing section 1001 receives beacon signals transmitted by the beacon transmitter 2. Specifically, the signal communication processing section 1001 receives beacon signals transmitted by the beacon transmitter 2 via the communication interface 107. Here, the signal communication processing section 1001 receives the beacon signals until the product sales data processing section 1005 (to be described later) receives a checkout instruction.

Further, the signal communication processing section 1001 authenticates the beacon transmitter 2. Specifically, upon reception of a beacon signal from the beacon transmitter 2, the signal communication processing section 1001 determines whether or not the beacon ID included in the beacon signal matches the beacon ID stored in association with the terminal ID stored in the ROM 102 of the terminal device 1 (see FIG. 3). If it is determined that they match each other, the terminal device 1 determines that the beacon signal has been transmitted from the beacon transmitter 2 that forms the pair with the terminal device 1, and acquires that beacon signal. Further, if it is determined that they do not match each other, the terminal device 1 determines that the beacon signal has been transmitted from another beacon transmitter other than the beacon transmitter 2 that forms the pair with the terminal device 1, and discards that beacon signal.

Note that the signal communication processing section 1001 may start receiving beacon signals when the detection processing section 1006, which will be described later, detects that the beacon transmitter 2 has been detached from the terminal device 1.

The location information acquisition section 1002 is an example of location information acquisition means. The location information acquisition section 1002 acquires location information indicating a location at which the terminal device 1 is present. Specifically, the location information acquisition section 1002 acquires location information of the terminal device 1 via the positioning device 108.

The calculation processing section 1003 is an example of acquisition means. The calculation processing section 1003 acquires information relating to a distance between the terminal device 1 and the beacon transmitter 2 on the basis of the beacon signal. Specifically, the calculation processing section 1003 calculates the distance between the terminal device 1 and the beacon transmitter 2 (hereinafter, referred to simply as distance) on the basis of the location information of the terminal device 1 acquired by the location information acquisition section 1002 and second location information indicating the location at which the beacon transmitter 2 is present, which is included in the beacon signal acquired by the signal communication processing section 1001.

The display control section 1004 is an example of first display means, second display means, and third display means. The display control section 1004 displays various screens in cooperation with other functional sections. The display control section 1004 displays information relating to the products registered by the product sales data processing section 1005, which will be described later, on the display device 105. Specifically, the display control section 1004 cooperates with the product sales data processing section 1005 to display the product registration screen Ga on the display device 105.

Further, the display control section 1004 displays first notification information on the display device 105 in accordance with the information relating to the distance between the terminal device 1 and the beacon transmitter 2, which is acquired by the calculation processing section 1003. Specifically, the display control section 1004 refers to the lost child determination table 1044 and acquires the display content corresponding to the distance calculated by the calculation processing section 1003. Further, if the acquired display content is a lost child alert screen, the display control section 1004 displays the lost child alert screen Gb or the lost child alert screen Gc on the display device 105.

Further, upon completion of the processing relating to registration by the product sales data processing section 1005, if the beacon transmitter 2 is not attached to the terminal device 1, the display control section 1004 displays second notification information on the display device 105. Specifically, when the detection processing section 1006, which will be described later, has not detected that the beacon transmitter 2 is attached to the terminal device 1, the display control section 1004 cooperates with the detection processing section 1006 to display the attachment alert screen Gd on the display device 105.

Further, when the controller 100 receives the operation of confirming the lost child alert screen (the button Gbb on the lost child alert screen Gb or the button Gcc on the lost child alert screen Gc) from the operation device 106, the display control section 1004 cancels the display of the lost child alert screen and displays the product registration screen Ga on the display device 105. Furthermore, when the controller 100 receives the operation of confirming the attachment alert screen Gd (the button Gdb on the attachment alert screen Gd) from the operation device 106, the display control section 1004 cancels the display of the attachment alert screen Gd and displays the product registration screen Ga on the display device 105.

The product sales data processing section 1005 is an example of registration means. The product sales data processing information capable section 1005 acquires identifying a product, and registers the product as a product to be purchased. Specifically, the product sales data processing section 1005 uses the imaging device 34 of the terminal device 1 to read a code symbol such as a bar code or a two-dimensional code of the product to be purchased to acquire a product code of the product. Next, the product sales data processing section 1005 refers to the product master 1042 to acquire product information of the product corresponding to the acquired product code. The product sales data processing section 1005 then stores the acquired product information in the product registration file 1031 of the terminal device 1.

Further, upon reception of a checkout instruction from the operation device 106 of the terminal device 1, the product sales data processing 1005 transmits the product information relating to one transaction stored in the product registration file 1031 to a checkout machine not shown in the figure.

The detection processing section 1006 detects that the beacon transmitter 2 has been attached to the terminal device 1. Specifically, when the product sales data processing section 1005 receives a checkout instruction, the detection processing section 1006 determines whether or not the beacon transmitter 2 has been attached to the terminal device 1 via the attachment/detachment sensor 111 of the terminal device 1.

If the detection processing section 1006 does not detect that the beacon transmitter 2 has been attached to the terminal device 1, the detection processing section 1006 cooperates with the display control section 1004 to display the attachment alert screen Gd on the display device 105. Further, if the detection processing section 1006 detects that the beacon transmitter 2 has been attached to the terminal device 1, the detection processing section 1006 determines whether or not the display control section 1004 is displaying the attachment alert screen Gd on the display device 105. If the attachment alert screen Gd is being displayed, the detection processing section 1006 cancels the display of the attachment alert screen Gd.

Note that if the detection processing section 1006 detects that the beacon transmitter 2 has been detached from the terminal device 1 via the attachment/detachment sensor 111, the detection processing section 1006 may cooperate with the display control section 1004 to display on the display device 105 a screen notifying that the reception of beacon signals is started.

On the other hand, the attachment/detachment detection section 2001 of the beacon transmitter 2 detects that its own beacon transmitter 2 has been attached to or detached from the terminal device 1 Specifically, upon detecting that the beacon transmitter 2 has been detached from a predetermined position of the terminal device 1 via the attachment/detachment sensor 208, the attachment/detachment detection section 2001 transmits a notification for notifying that the beacon transmitter 2 has been detached (hereinafter, referred to as detachment notification) to the controller 200.

Further, upon detecting that the beacon transmitter 2 has been attached to a predetermined position of the terminal device 1, the attachment/detachment detection section 2001 transmits a notification for notifying that the beacon transmitter 2 has been attached to the predetermined position (hereinafter, referred to as attachment notification) to the controller 200.

The power supply control section 2002 controls the power supply of the beacon transmitter 2 and switches between the on-state and the off-state of the beacon transmitter 2. Specifically, when the controller 200 receives the detachment notification, the power supply control section 2002 switches the beacon transmitter 2 to the on-state. Further, when the controller 200 receives the attachment notification, the power supply control section 2002 switches the beacon transmitter 2 to the off-state.

The location information acquisition section 2003 acquires location information indicating a location at which the beacon transmitter 2 is present. Specifically, the location information acquisition section 2003 acquires the location information of the beacon transmitter 2 via the positioning device 206.

The signal communication processing section 2004 transmits a beacon signal. Specifically, the signal communication processing section 2004 transmits a beacon signal including the beacon ID stored in the ROM 202 of the beacon transmitter 2 and the location information of the beacon transmitter 2.

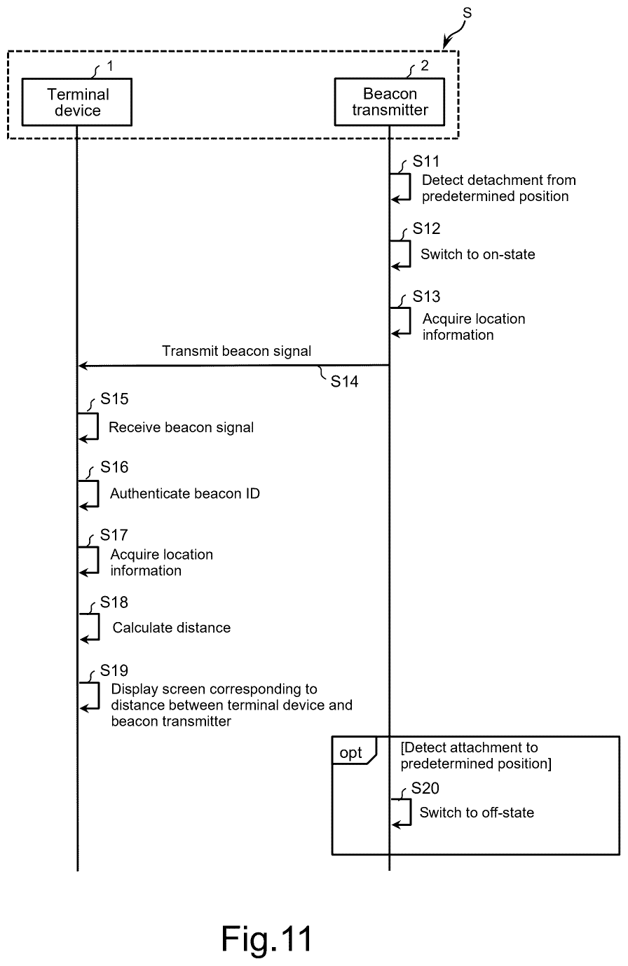

Next, the control processing of the lost child prevention system S will be described. FIG. 11 is a sequence diagram showing an example of the control processing of the lost child prevention system S according to this embodiment. The sequence diagram shown in FIG. 11 shows a processing example when the terminal device 1 receives the beacon signal transmitted from the beacon transmitter 2 and calculates the distance on the basis of the location information of the beacon transmitter 2 included in the beacon signal and the location information of the terminal device 1.

First, upon detecting that the beacon transmitter 2 has been detached from the predetermined position of the terminal device 1, the attachment/detachment detection section 2001 of the beacon transmitter 2 transmits a detachment notification to the controller 200 (Step S11). Next, when the controller 200 receives the detachment notification from the attachment/detachment detection section 2001, the power supply control section 2002 of the beacon transmitter 2 switches the beacon transmitter 2 to the on-state (Step S12).

Subsequently, the location information acquisition section 2003 of the beacon transmitter 2 acquires the location information of the beacon transmitter 2 via the positioning device 206 (Step S13). Next, the signal communication processing section 2004 of the beacon transmitter 2 transmits a beacon signal including the beacon ID stored in the ROM 202 of the beacon transmitter 2 and the location information of the beacon transmitter 2 (Step S14).

Meanwhile, the signal communication processing section 1001 of the terminal device 1 receives the beacon signal transmitted by the beacon transmitter 2 via the communication interface 107 (Step S15). Next, the signal communication processing section 1001 authenticates the beacon ID included in the beacon signal (Step S16). Here, if the beacon ID is the beacon ID of the beacon transmitter 2 that is paired with the terminal device 1, the location information acquisition section 1002 of the terminal device 1 acquires the location information of the terminal device 1 via the positioning device 108 (Step S17).

Next, the calculation processing section 1003 of the terminal device 1 calculates the distance on the basis of the location information of the terminal device 1 acquired by the location information acquisition section 1002 and the location information of the beacon transmitter 2 included in the beacon signal (Step S18). The display control section 1004 then displays the screen corresponding to the distance calculated by the calculation processing section 1003 on the display device 105 of the terminal device 1 (Step S19).

Meanwhile, when the controller 200 receives an attachment notification from the attachment/detachment detection section 2001, the power supply control section 2002 of the beacon transmitter 2 switches the beacon transmitter 2 to the off-state (Step S20).

When the terminal device 1 receives the beacon signal transmitted from the beacon transmitter 2 by the processing described above, the terminal device 1 calculates the distance on the basis of the location information of the beacon transmitter 2 included in the beacon signal and the location information of the terminal device 1. The terminal device 1 then displays a lost child alert screen in accordance with the distance between the terminal device 1 and the beacon transmitter 2 on the display device 105. This allows the operator of the shopping cart 3 (e.g., guardian) to be notified, in a stepwise manner, that the child is likely to get lost.

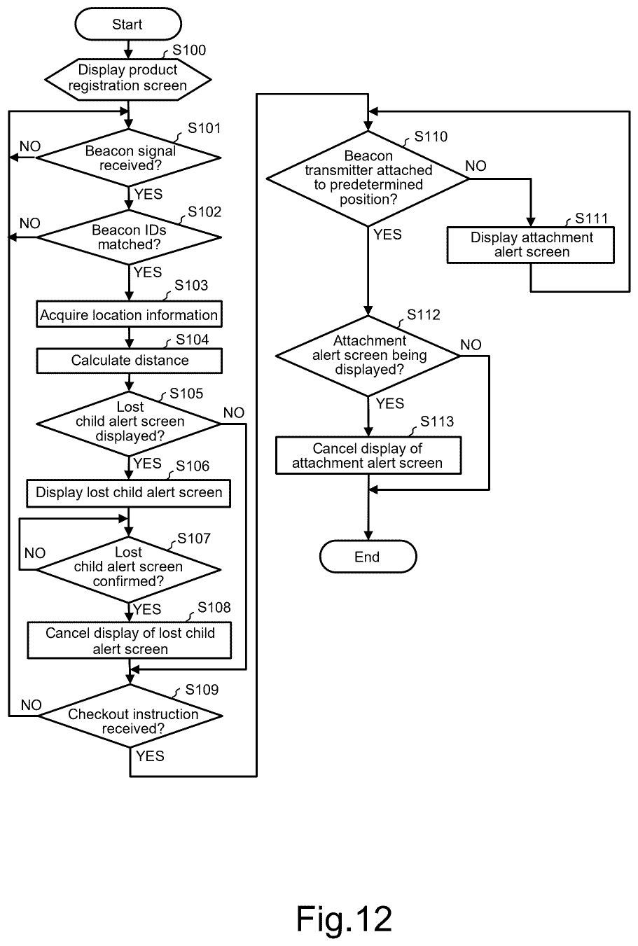

Next, the control processing of the controller 100 of the terminal device 1 will be described with reference to FIG. 12. FIG. 12 is a flowchart showing an example of the control processing of the terminal device 1 according to this embodiment. In the flowchart of FIG. 12, a lost child alert screen is displayed on the display device 105 in accordance with the distance between the terminal device 1 and the beacon transmitter 2, which has been calculated by the terminal device 1. Further, FIG. 12 shows a processing example of determining whether or not the beacon transmitter 2 has been attached to a predetermined position of the terminal device 1 when the terminal device 1 receives a checkout instruction. Note that, as a precondition for this processing, it is assumed that the product registration screen Ga is displayed on the display device 105 of the terminal device 1 (Step S100).

First, the signal communication processing section 1001 of the terminal device 1 waits until it receives a beacon signal from the beacon transmitter 2 (Step S101; No). When receiving the beacon signal (Step S101; Yes), the signal communication processing section 1001 determines whether or not the beacon ID included in the beacon signal matches the beacon ID stored in the ROM 102 of the terminal device 1 (Step S102).

If the beacon ID included in the beacon signal does not match the beacon ID stored in the ROM 102 of the terminal device 1 (Step S102; No), the signal communication processing section 1001 discards that beacon signal and returns the processing to Step S101. Further, if the beacon ID included in the beacon signal matches the beacon ID stored in the ROM 102 of the terminal device 1 (Step S102; Yes), the location information acquisition section 1002 of the terminal device 1 acquires location information of the terminal device 1 via the positioning device 108 (Step S103). Next, the calculation processing section 1003 of the terminal device 1 calculates the distance between the two devices on the basis of the location information of the terminal device 1 acquired in Step S103 and the location information of the beacon transmitter 2 included in the beacon signal (Step S104).

Next, the display control section 1004 refers to the lost child determination table 1044 and acquires a display content corresponding to the distance calculated by the calculation processing section 1003. The display control section 1004 then determines whether or not the acquired display content is a lost child alert screen (Step S105). If the acquired display content is not a lost child alert screen (Step S105; No), the display control section 1004 proceeds to Step S109.

Further, if the acquired display content is a lost child alert screen (Step S105; Yes), the display control section 1004 displays the lost child alert screen on the display device 105 of the terminal device 1 (Step S106). Next, the controller 100 of the terminal device 1 waits until it receives an operation of confirming the lost child alert screen (the button Gbb on the lost child alert screen Gb or the button Gcc on the lost child alert screen Gc) from the operation device 106 (Step S107; No).

Upon reception of the operation of confirming the lost child alert screen (Step S107; Yes), the display control section 1004 cancels the display of the lost child alert screen (Step S108). Next, the product sales data processing section 1005 of the terminal device 1 determines whether or not a checkout instruction has been received from the operation device 106 of the terminal device 1 (Step S109).

If no checkout instruction has been received (Step S109; No), the controller 100 returns the processing to Step S101. If a checkout instruction has been received (Step S109; Yes), the product sales data processing section 1005 transmits the product information relating to one transaction stored in the product registration file 1031 to a checkout machine not shown in the figure.

Next, the detection processing section 1006 of the terminal device 1 determines whether or not it detects that the beacon transmitter 2 has been attached to the terminal device 1 via the attachment/detachment sensor 111 of the terminal device 1 (Step S110). When the detection processing section 1006 does not detect that the beacon transmitter 2 has been attached to the terminal device 1 (Step S110; No), the detection processing section 1006 cooperates with the display control section 1004 to display the attachment alert screen Gd on the display device 105 of the terminal device 1 (Step S111). The controller 100 then returns the processing to Step S110.

When the detection processing section 1006 detects that the beacon transmitter 2 has been attached to the terminal device 1 (Step S110; Yes), the detection processing section 1006 determines whether or not the display control section 1004 is displaying the attachment alert screen Gd on the display device 105 (Step S112). If the attachment alert screen Gd is being displayed, the detection processing section 1006 cancels the display of the attachment alert screen Gd (Step S113) and terminates the processing. Further, if the attachment alert screen Gd is not being displayed (Step S112; No), the controller 100 terminates the processing.

Note that if the display content acquired in Step S105 is a lost child alert screen, the lost child alert screen to be displayed on the display device 105 in Step S106 reflects the type of lost child alert screen (the lost child alert screen Gb or the lost child alert screen Gc).

As described above, in the lost child prevention system S of this embodiment, when the terminal device 1 receives a beacon signal transmitted from the beacon transmitter 2, the terminal device 1 calculates the distance on the basis of the location information of the beacon transmitter 2 included in the beacon signal and the location information of the terminal device 1. Further, the terminal device 1 displays a lost child alert screen corresponding to the distance between the terminal device 1 and the beacon transmitter 2 on the display device 105. Furthermore, when the terminal device 1 receives a checkout instruction, it determines whether or not the beacon transmitter 2 has been attached to the predetermined position of the terminal device 1.

Accordingly, in the lost child prevention system S of this embodiment, displaying the lost child alert screen in accordance with the distance between the terminal device 1 and the beacon transmitter 2 makes it possible to notify, in a stepwise manner, the operator of the shopping cart 3 (e.g., guardian) that the child is likely to get lost. Further, displaying the in-store map on the lost child alert screen makes it possible to easily find the lost child when such a situation occurs. Furthermore, the product registration screen Ga is grayed out and the lost child alert screen is displayed, which allows the operator of the shopping cart 3 to promptly notice a situation in which the child is likely to get lost. Therefore, the occurrence of a lost child can be prevented in the store.

Further, in the lost child prevention system S of this embodiment, upon receiving a checkout instruction, the terminal device 1 can determine whether or not the beacon transmitter 2 has been attached to a predetermined position of the terminal device 1, and if the beacon transmitter 2 is not attached, the terminal device 1 can display an attachment alert screen. This can prevent the loss of the beacon transmitter 2.

### Second Embodiment

Next, a second embodiment will be described. In the second embodiment, a configuration in which the beacon signal transmitted by the beacon transmitter 2 is relayed through one or more relay devices 5 and the relayed beacon signal can be received by the terminal device 1 will be described on the basis of the configuration of the lost child prevention system S in the first embodiment. Note that, in the following, the points that differ from the embodiment described above will be mainly described, and detailed description will be omitted for points that are common in those already described.

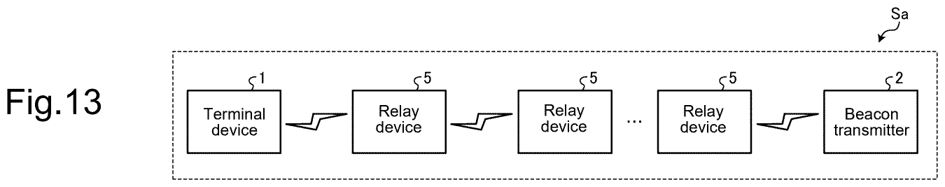

FIG. 13 is a diagram showing an example of a schematic configuration of a lost child prevention system Sa according to the second embodiment. As shown in FIG. 13, the lost child prevention system Sa includes a terminal device 1, a beacon transmitter 2, and a plurality of relay devices 5. Note that in this embodiment the communicable range between the terminal device 1 and the beacon transmitter 2 is assumed to be a smaller than the range of the store.

The relay devices 5 are installed at multiple locations within the store and are configured to be communicable with each other. For example, the relay devices 5 form a mesh network within the store.

When a relay device 5 receives a beacon signal from the beacon transmitter 2, the relay device 5 transmits the beacon signal to be transferred to another relay 5. Further, when a relay device 5 receives a beacon signal from another relay device 5, the relay device 5 transmits the beacon signal to be transferred to still another relay 5. Accordingly, the beacon signal transmitted from the beacon transmitter 2 is transmitted within the store via the relay devices 5.

Further, the terminal device 1 of this embodiment receives the beacon signal transmitted from the beacon transmitter 2 and also receives the beacon signal transmitted via the relay devices 5.

Accordingly, even if the terminal device 1 and the beacon transmitter 2 are located at such a distance that direct communication is not possible, the beacon signal can be transmitted to the terminal device 1 by transferring the beacon signal, which has been transmitted by the beacon transmitter 2, through the plurality of relay devices 5. Therefore, even if the beacon transmitter 2 is beyond the communicable range, the terminal device 1 can receive the beacon signal via the relay devices 5, and can thus identify the location at which the beacon transmitter 2 is present and display a notification screen. Therefore, the same effects as in the first embodiment described above can be achieved.

Note that in this embodiment it is favorable to provide a mechanism to prevent duplicate reception (duplicate transmission) of a beacon signal transmitted by a relay device 5 as a beacon signal transmitted by another relay device 5 that has received the former beacon signal. For example, each relay device 5 may transfer a beacon signal including a relay device ID that can identify its own relay device 5. In this case, each relay device 5 transfers a beacon signal that does not include the relay device ID of the relay device 5 and discards the beacon signal including the relay device ID of the relay device 5, thus enabling prevention of duplicate transmission of beacon signals.

Note that the embodiments described above can also be implemented by changing some of the configurations or functions of the devices described above and modifying the embodiments as appropriate. In this regard, some modifications according to the embodiments described above will be described below as other embodiments. Note that, in the following, the points that differ from the embodiments described above will be mainly described, and detailed description will be omitted for points that are common in those already described. Further, the modifications described below may be implemented individually or in combination as appropriate.

### Modification 1

In the embodiments described above, upon receiving a checkout instruction from the operation device 106, the product sales data processing section 1005 of the terminal device 1 transmits the product information relating to one transaction stored in the product registration file 1031 to a checkout machine not shown in the figure, but the embodiments are not limited thereto. Upon receiving a checkout instruction from the operation device 106, the product sales data processing section 1005 may also generate checkout information from the product information relating to one transaction stored in the product registration file 1031. In this case, the product sales data processing section 1005 executes the checkout processing by reading non-cash media such as a credit card of a customer via a reading section of the terminal device 1 not shown in the figure.

### Modification 2

In the embodiments described above, the beacon transmitter 2 is detachably attached to, for example, a predetermined position such as the back side of the terminal device 1 as shown in FIG. 2A, but the embodiments are not limited thereto. The predetermined position where the beacon transmitter 2 is attached may be any position of the shopping cart 3 as long as power can be supplied thereto from the battery 4, for example. In this case, the attachment/detachment of the beacon transmitter 2 to and from the predetermined position only needs to be detected by the attachment/detachment sensor (not shown) provided to the shopping cart 3, to thereby transmit a detection result to the terminal device 1.

### Modification 3

The embodiments described above provide the configuration in which the distance calculated from the location information of the terminal device 1 and the location information of the beacon transmitter 2 is used as an example of the information relating to the distance between the terminal device 1 and the beacon transmitter 2, but the embodiments are not limited thereto. For example, a received radio wave strength (received signal strength indicator: RSSI) of the beacon signal received by the terminal device 1 may be used as information relating to the distance between the terminal device 1 and the beacon transmitter 2.

In this case, the lost child determination table 1044 uses the RSSI instead of the distance. Further, regarding each functional section of the terminal device 1, the signal communication processing section 1001 acquires RSSI, and the display control section 1004 refers to the lost child determination table 1044 and acquires the display content corresponding to the RSSI acquired by the signal communication processing section 1001. The display control section 1004 then displays the acquired display content on the display device 105. Therefore, in this case, the location information acquisition section 1002 and the calculation processing section 1003 of the terminal device 1 are not necessarily indispensable.

### Modification 4

The embodiments described above provide the configuration in which the display control section 1004 of the terminal device 1 displays the lost child alert screen Gb and the lost child alert screen Gc with the product registration screen Ga being grayed out, but the embodiments are not limited thereto. Instead of making the product registration screen Ga grayed out, the display control section 1004 may display an operation element for displaying each lost child alert screen at any position on the display region G when each lost child alert screen is displayed, and may display each lost child alert screen when the operation of the operation element is received from the operation device 106.

### Modification 5

In the first embodiment described above, the communication between the terminal device 1 and the beacon transmitter 2 is made possible in the entire region of the store, but the embodiments are not limited thereto. The range where the communication between the terminal device 1 and the beacon transmitter 2 is made possible may be smaller than the range of the store. In this case, the display control section 1004 of the terminal device 1 displays a screen that notify a situation in which the child is likely to get lost, such as the lost child alert screen Gb or the lost child alert screen Gc, when communication with the beacon transmitter 2 is disconnected. Note that the disconnection of communication may be determined from one or several times of disconnection of the beacon signals transmitted at predetermined intervals or may be determined from an interruption of the calculation of the distance, with the beacon transmitter 2 being detached.

Performing the above processing makes it possible to promptly notify the operator of the terminal device 1 that the distance between the terminal device 1 and the beacon transmitter 2 hinders communication therebetween, thereby preventing the occurrence of a lost child and detecting the lost child at an early stage.

Note that the programs to be executed in the lost child prevention system S and the lost child prevention system Sa of the embodiments and modifications may be configured to be provided by being stored on a computer connected to a network such as the Internet and by being downloaded via a network. Further, the programs to be executed in the lost child prevention system S and the lost child prevention system Sa of the embodiments and modifications may be configured to be provided or distributed via a network such as the Internet.

Note that the programs to be executed by each device of the embodiments described above are provided by being pre-embedded in the ROM, the storage section, or the like. The programs to be executed by each device of the embodiments described above may be provided by being recorded on computer-readable recording media such as a CD-ROM, a flexible disk (FD), a CD-R, and a digital versatile disc (DVD) in an installable or executable format file.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that is operated by a customer who comes to a store and is capable of moving around the store together with the customer, the information processing apparatus comprising:
a beacon device that is detachably attached to the information processing apparatus and transmits a beacon signal;
an input device that inputs product identification information of a product to be purchased, the product identification information being information capable of identifying the product;
a communication interface that communicates with the beacon device;
a display device that displays information relating to the product and notification information for the customer; and
a controller configured to
acquire the product identification information input by the input device and register the information relating to the product identified by the acquired product identification information, as information of a product to be purchased,
display the registered information relating to the product on the display device,
receive the beacon signal transmitted from the beacon device via the communication interface,
acquire information relating to a distance between the information processing apparatus and the beacon device on a basis of the received beacon signal, and
display first notification information on the display device in accordance with the acquired information relating to the distance, the first notification information being different from the information relating to the product.

2. The information processing apparatus according to claim 1, further comprising
a positioning device that acquires first location information indicating a location of the information processing apparatus in the store, wherein
the beacon signal includes second location information indicating a location of the beacon device, and
the controller calculates information relating to the distance between the information processing apparatus and the beacon device on a basis of the first location information and the second location information.

3. The information processing apparatus according to claim 1, wherein
the controller acquires a received radio wave strength of the beacon signal as the information relating to the distance from the information processing apparatus.

4. The information processing apparatus according to claim 1, wherein
the controller receives the beacon signal until processing relating to registration is terminated.

5. The information processing apparatus according to claim 1, further comprising
an attachment/detachment sensor that detects that the beacon device is attached to or detached from the information processing apparatus, wherein
the controller displays second notification information on the display device when the processing relating to registration is terminated and it is detected that the beacon device is not attached to the information processing apparatus, the second notification information being different from the first notification information.

6. The information processing apparatus according to claim 1, wherein
the controller displays a product registration screen on the display device when the acquired distance has a predetermined value or less, the product registration screen including the registered information relating to the product.

7. The information processing apparatus according to claim 1, wherein
the controller displays an alert screen on the display device when the acquired distance exceeds a predetermined value, the alert screen including the first notification information.

8. The information processing apparatus according to claim 1, further comprising
a storage device, wherein
the storage device includes a determination table that stores a display content corresponding to the distance between the information processing apparatus and the beacon device, and
the controller refers to the determination table and acquires the display content corresponding to the acquired distance, to display on the display device a product registration screen including the registered information relating to the product or an alert screen including the first notification information.

9. The information processing apparatus according to claim 2, further comprising
a memory that stores beacon identification information for identifying the beacon device, wherein
the beacon signal includes beacon identification information of the beacon device, and
the controller acquires the first location information via the positioning device when the beacon identification information stored in the memory matches the beacon identification information included in the received beacon signal.

10. A method of controlling an information processing apparatus that is operated by a customer who comes to a store and is capable of moving around the store together with the customer, the method comprising:
acquiring product identification information input by an input device, the product identification information being information for identifying a product;
registering information relating to a product identified by the acquired product identification information, as information of a product to be purchased;
displaying the registered information relating to the product on a display device;
receiving a beacon signal transmitted from a beacon device detachably attached to the information processing apparatus via a communication interface;
acquiring information relating to a distance between the information processing apparatus and the beacon device on a basis of the received beacon signal; and
displaying notification information on the display device in accordance with the acquired information relating to the distance.
